(19) United States
(12) Patent Application Publication
(10) Pub. No.: US 2018/0063426 A1
(43) Pub. Date: Mar. 1, 2018

(54) METHOD, APPARATUS AND COMPUTER PROGRAM PRODUCT FOR INDICATING A SEAM OF AN IMAGE IN A CORRESPONDING AREA OF A SCENE

(71) Applicant: Nokia Technologies Oy, Espoo (FI)

(72) Inventor: Tero Rissa, Siivikkala (FI)

(21) Appl. No.: 15/252,926

(22) Filed: Aug. 31, 2016

(51) Int. Cl. H04N 5/232; H04N 5/225; H04N 5/247

(52) U.S. Cl. CPC H04N 5/23238; H04N 5/247; H04N 5/2256; H04N 5/23293

(57) ABSTRACT

A method, apparatus and computer program product are provided for indicating a seam of a subject image, such as a panoramic image generated from multiple images, in a corresponding area of a scene. Information may be received regarding the position, settings, and/or other attributes of a camera(s). A seam of the subject image to be taken of the scene, or generated as a panoramic image from multiple images of the scene may then be determined. The seam may be the actual or predicted seam of the subject image where two or more images may be stitched together. An indication of the seam may be provided in the scene, such as by emitting light in an area corresponding to the seam. A warning may be provided via a user interface, indicating that degradation may occur in the area of the scene corresponding to the seam.

### TECHNOLOGICAL FIELD

An example embodiment of the present invention relates generally to user interfaces, and more particularly, to a method, apparatus and computer program product for indicating a seam of an image in a corresponding area of a scene.

### BACKGROUND

In multi-camera systems, images captured from different cameras may be combined to create panoramic images. In some examples, multiple cameras may be housed in the same device and configured to capture a 360° image. Unlike in rotational panorama cameras, where the multiple images are combined from a camera that rotates around its axis, using multiple cameras to photograph or capture a scene may result in disparity between the viewpoints. Capturing the images from different viewpoints or with different camera may therefore cause the resultant panoramic images to be distorted or blurred, particularly in the areas of the seams connecting or stitching together the images.

There is no perfect computational solution to improve or eliminate the distortion that may occur in the area of a seam when images taken from different viewpoints are combined or stitched together. One consideration may be to manually process the images with photo editing software to create a clearer, more realistic seam or a “seamless” panoramic image. This requires extensive manual manipulation of the images after the images are captured, however, and can be extremely time consuming for the user.

### BRIEF SUMMARY

A method, apparatus, and computer program product are therefore provided for indicating a seam of an image in a corresponding area of a scene. Example embodiments receive information regarding the position, settings, and/or other attributes of a camera or cameras. Example embodiments may then determine or estimate a seam of a subject image to be taken of the scene, or generated as a panoramic image from multiple images of the scene. The seam may be the actual or predicted seam of the subject image. Example embodiments may then provide an indication in the scene in the area corresponding to the seam of the subject image. For example, laser light may be emitted, such as from the same device housing the camera, into the scene in the area corresponding to the seam. A user may then direct the camera and/or alter the scene based on the indication so that the seam is in a more desirable area of the image to be captured, or an area which results in less blur or distortion of the subject image.

An apparatus is provided that includes at least one processor and at least one memory including computer program code with the at least one memory and the computer program code configured to, with the processor, cause the apparatus to at least: receive a camera attribute indication including at least one camera attribute; process the at least one camera attribute to determine a seam of a subject image of a scene based on the at least one camera attribute; and cause an indication of the seam of the subject image to be provided in the scene.

In some embodiments, the at least one memory and the computer program code are further configured to cause the apparatus to at least determine that a degradation in quality would occur in the subject image based on the determined seam of the subject image of the scene. In some examples, determining that the degradation in quality would occur comprises determining that an object within the area of the scene corresponding to the seam is within a threshold distance of a camera. In some embodiments, the at least one memory and the computer program code are further configured to cause the apparatus to at least, in response to determining that the degradation in quality would occur, cause a warning to be provided via a user interface.

A computer program product is provided that includes at least one non-transitory computer-readable storage medium having computer-executable program code instructions stored therein with the computer-executable program code instructions comprising program code instructions to: receive a camera attribute indication including at least one camera attribute; process the at least one camera attribute to determine a seam of a subject image of a scene based on the at least one camera attribute; and cause an indication of the seam of the subject image to be provided in the scene.

In some embodiments, the functionality of the computer program product may be implemented as programmable logic in a Field Programmable Gate Array (FPGA) or combination of FPGA logic and computer executable code or a computer executable program.

In some embodiments, the computer-executable program code instructions further comprise program code instructions to determine that a degradation in quality would occur in the subject image based on the determined seam of the subject image of the scene. In some examples, determining that the degradation in quality would occur comprises determining that an object within the area of the scene corresponding to the seam is within a threshold distance of a camera. In some embodiments, the computer-executable program code instructions further comprise program code instructions to, in response to determining that the degradation in quality would occur, cause a warning to be provided via a user interface.

A method is provided that includes receiving a camera attribute indication including at least one camera attribute; processing, with a processor, the at least one camera attribute to determine a seam of a subject image of a scene based on the at least one camera attribute; and causing an indication of the seam of the subject image to be provided in the scene.

In some embodiments, the method includes determining that a degradation in quality would occur in the subject image based on the determined seam of the subject image of the scene. In some examples, determining that the degradation in quality would occur comprises determining that an object within the area of the scene corresponding to the seam is within a threshold distance of a camera. In some embodiments, the method further includes, in response to determining that the degradation in quality would occur, causing a warning to be provided via a user interface.

An apparatus is provided that includes means for receiving a camera attribute indication including at least one camera attribute; means for processing the at least one camera attribute to determine a seam of a subject image of a scene based on the at least one camera attribute; and means for causing an indication of the seam of the subject image to be provided in the scene.

In some embodiments, the apparatus includes means for determining that a degradation in quality would occur in the subject image based on the determined seam of the subject image of the scene. In some examples, determining that the degradation in quality would occur comprises determining that an object within the area of the scene corresponding to the seam is within a threshold distance of a camera. In some embodiments, the apparatus further includes means for, in response to determining that the degradation in quality would occur, causing a warning to be provided via a user interface.

In some embodiments, causing the indication of the seam to be provided in the scene comprises causing light to be emitted in the scene in an area corresponding to the seam of the subject image of the scene. In some examples, the subject image is a panoramic image to be generated by adjoining two images at the seam, and the at least one camera attribute comprises at least two camera attributes attributed to at least two different cameras. In some embodiments, the indication of the seam of the subject image is provided in the scene in response to a user input requesting the indication of the seam.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus that may be configured to implement example embodiments of the present invention;

FIG. 2 is a block diagram of a system that may be configured to utilize an apparatus according to example embodiments of the present invention;

FIG. 3 is a flowchart illustrating operations performed in accordance with example embodiments of the present invention;

FIG. 4A is a view of a scene;

FIG. 4B is a panoramic image of the scene of FIG. 4A;

FIG. 4C is a view of the scene of FIG. 4A wherein an example embodiment is employed;

FIG. 4D is a view of the scene of FIGS. 4A and 4C, wherein an example embodiment is employed; and

FIG. 4E is a panoramic image of the scene of FIG. 4C, wherein an example embodiment is employed.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, field programmable gate array, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

As described below, a method, apparatus and computer program product are provided for indicating a seam of an image in a corresponding area of a scene. As described hereinafter, attributes of the camera may be processed to determine a seam of an image. In this regard, any reference to an image or images made herein is non-limiting and may include either photographs and/or video imagery. A seam may therefore refer to the adjoining points of two or more images or video image that are combined to form a panoramic image or panoramic video imagery. As also described herein, the seam may be considered a border of a subject image or video.

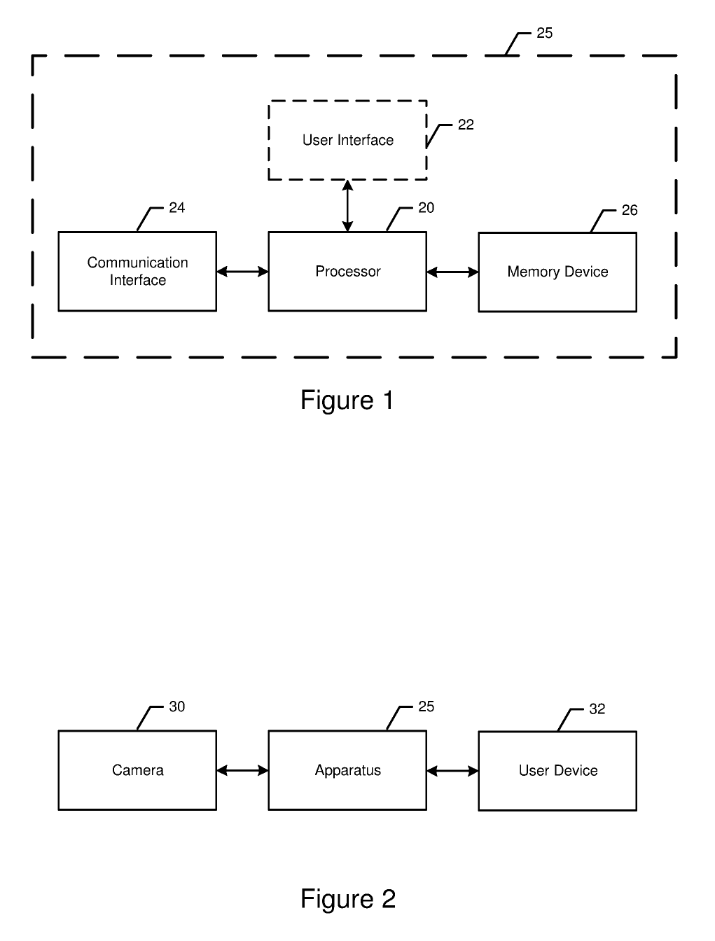

Referring to FIG. 1, apparatus 25 may include or otherwise be in communication with a processor 20, communication interface 24, and memory device 26. As described below and as indicated by the dashed lines in FIG. 1, in some embodiments, the apparatus 25 may also optionally include a user interface 22. Apparatus 25 may be implemented as a server or distributed system, such as a server for directing camera positioning, control, image capture, and/or the like. In some example, apparatus 25 need not necessarily be embodied by a server, and may be embodied by a wide variety of devices including personal computers, work stations, or mobile terminals, such as laptop computers, tablet computers, smartphones or any combination of the aforementioned, and other types of voice and text communications systems. In some example, apparatus 25 may be embodied within an image capture device such as a camera.

In some embodiments, the processor 20 (and/or co-processors or any other processing circuitry assisting or otherwise associated with the processor 20) may be in communication with the memory device 26 via a bus for passing information among components of the apparatus 25. The memory device 26 may include, for example, one or more volatile and/or non-volatile memories. In other words, for example, the memory device 26 may be an electronic storage device (e.g., a computer readable storage medium) comprising gates configured to store data (e.g., bits) that may be retrievable by a machine (e.g., a computing device like the processor 20). The memory device 26 may be configured to store information, data, content, applications, instructions, or the like for enabling the apparatus to carry out various functions in accordance with an example embodiment of the present invention. For example, the memory device 26 could be configured to buffer input data for processing by the processor 20. Additionally or alternatively, the memory device 26 could be configured to store instructions for execution by the processor 20.

The apparatus 25 may, in some embodiments, be embodied in various devices as described above. However, in some embodiments, the apparatus 25 may be embodied as a chip or chip set. In other words, the apparatus 25 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 25 may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 26 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., a mobile terminal or network entity) configured to employ an embodiment of the present invention by further configuration of the processor 20 by instructions for performing the algorithms and/or operations described herein. The processor 20 may include, among other things, a clock, an arithmetic logic unit (ALU) and logic gates configured to support operation of the processor 20.

Meanwhile, the communication interface 24 may be any means such as a device or circuitry embodied in either hardware or a combination of hardware and software that is configured to receive and/or transmit data from/to a network and/or any other device or module in communication with the apparatus 25. In this regard, the communication interface 24 may include, for example, an antenna (or multiple antennas) and supporting hardware and/or software for enabling communications with a wireless communication network. Additionally or alternatively, the communication interface 24 may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface 24 may include a communication modem and/or other hardware/software for supporting communication via cable, digital subscriber line (DSL), universal serial bus (USB) or other mechanisms.

In some embodiments, such as instances in which the apparatus 25 is embodied by a user device, the apparatus 25 may include a user interface 22 that may, in turn, be in communication with the processor 20 to receive an indication of a user input and/or to cause provision of an audible, visual, mechanical or other output to the user. As such, the user interface 22 may include, for example, a keyboard, a mouse, a joystick, a display, a touch screen(s), touch areas, soft keys, a microphone, a speaker, or other input/output mechanisms. Alternatively or additionally, the processor 20 may comprise user interface circuitry configured to control at least some functions of one or more user interface elements such as, for example, a speaker, ringer, microphone, display, and/or the like. The processor 20 and/or user interface circuitry comprising the processor 20 may be configured to control one or more functions of one or more user interface elements through computer program instructions (e.g., software and/or firmware) stored on a memory accessible to the processor 20 (e.g., memory device 26, and/or the like). In some embodiments, such as instances in which the apparatus 25 is embodied by a user device, the apparatus 25 may include a camera (e.g., camera 30 described below) or other image capturing device, which is configured to capture images, including video images.

FIG. 2 is a block diagram of a system that may be configured to utilize an apparatus, such as apparatus 25, according to example embodiments. In some examples, such as those in which apparatus 25 is implemented as a server, apparatus 25 may be implemented remotely from any number of cameras 30 and user devices 32, and may be configured to communicate with the cameras 30 and user devices 32 over a network.

In this regard, the user device 32 may be used to control cameras 30, either directly, or via apparatus 25. In some examples, however, apparatus 25 may be partially and/or wholly implemented within camera 30 and/or user device 32. In general, apparatus 25 may receive and/or process information relating to any of the cameras 30, such as camera attributes (e.g., positioning, angle, focus, zoom, etc.). Apparatus 25 may determine a seam of an image and cause an indication of the seam to be provided in the scene. For example, the apparatus 25 may cause light to be emitted in the scene in an area corresponding to the seam. The light may be emitted by any of the camera 30, user device 32, and/or apparatus 25. In this regard, the camera 30 may be any device that houses a camera and is configured for image capture, although the device may include other components, but for simplicity, is referred to herein as simply camera or cameras 30.

Camera 30 may therefore comprise a processor, such as processor 20 and/or a communication interface, such as communication interface 24, which may be configured for communicating with apparatus 25 and/or user device 32. For example, camera 30 may transmit images or camera attributes to the apparatus 25 and/or user device 32. In some examples, camera 30 may include a memory device, such as memory device 26. In some embodiments, multiple cameras 30 may be implemented within a single housing, such as in the Nokia OZO® virtual reality camera, which includes a spherical housing comprising several cameras, oriented to capture and/or generate 360° images based on the images captured from the multiple cameras. Example embodiments may additionally be utilized with multiple independent cameras 30 situated around a common scene. As another example, a camera 30 may move from one position to another, to capture images from different viewpoints, which may also be combined to form panoramic images.

User device 32 may be any device configured for use by a user, such as that used to remotely control any number of cameras 30. For example, a director or other user may use a user device 32 to direct any of the cameras 30 and receive feedback regarding their positioning or other attributes and adjust them accordingly. For example, the user device 32 may replicate a viewfinder for all or any of the cameras, so that the user can view the subject image to be captured and adjust the cameras 30 accordingly. The user device 32 may communicate with the camera 30 over a local area network. The user device 32 may therefore include a processor, such as processor 20, communication interface such as communication interface 24, user interface, such as user interface 22, and/or a memory device, such as memory device 26. User device 32 may be embodied by a wide range of devices including personal devices and mobile devices such as a smart phone, personal navigation system, wearable device, and/or the like. In some examples, the user device 32 may be embodied by the same device as the camera 30.

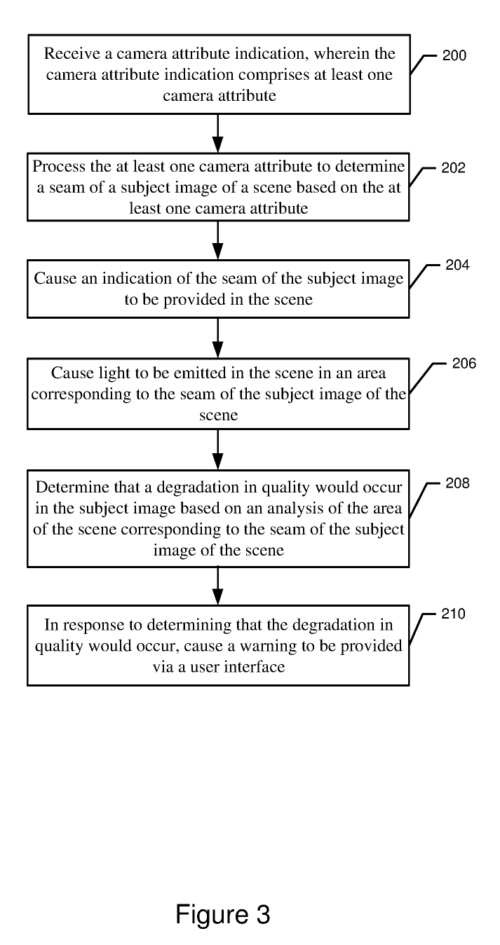

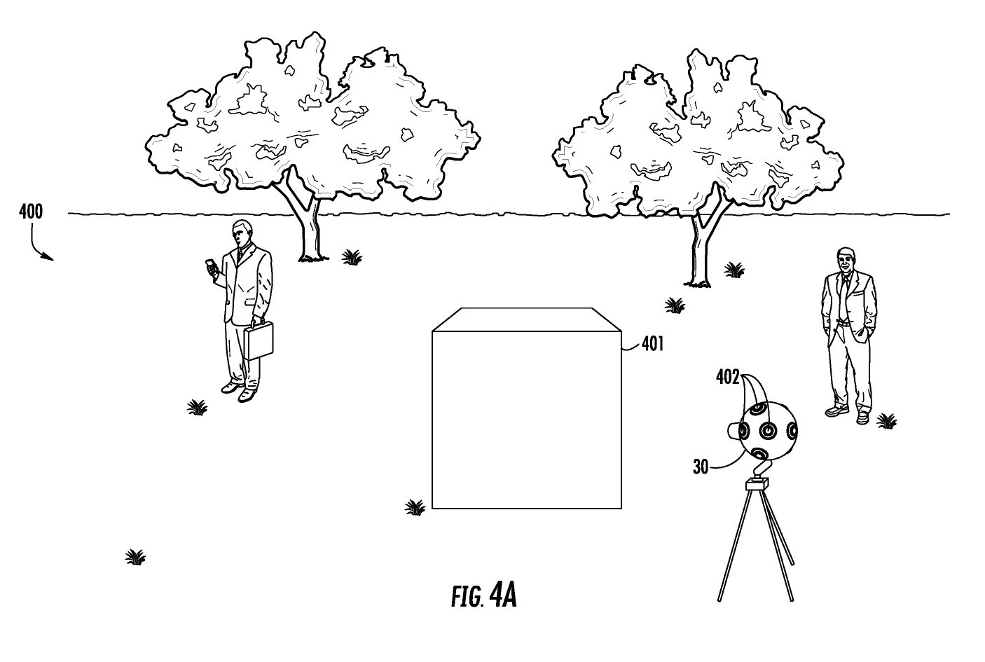

Referring now to FIG. 3, the operations for indicating a seam of an image in a corresponding area of a scene are outlined in accordance with an example embodiment. In this regard and as described below, the operations of FIG. 3 may be performed by an apparatus 25.

As shown by operation 200, the apparatus 25 may include means, such as the processor 20, the user interface 22, the communication interface 24 or the like, for receiving a camera attribute indication, wherein the camera attribute indication comprises a plurality of camera attributes. The camera attributes may include any properties or characteristics of camera(s) 30, such as those affecting an image to be captured from any of the cameras. For example, the camera attributes may include position and/or angle. In this regard, the camera attribute may apply to the physical device embodying the camera, or the lens within the camera. Example camera attributes may further include focus, zoom, and/or the like. In some examples the camera attributes may be detected from settings of the camera 30, or may be detected by various sensors on the camera 30.

The camera attributes received by apparatus 25 may be attributed to any number of cameras 30. In some examples, the camera attribute indication may be transmitted to apparatus 25 in response to a user input or user request, such as by user device 32. For example, a user may indicate by the push of a button or other input to indicate the user would like to position the camera 30 preferentially for the capture of multiple images to form a panoramic image, and the camera attribute indication may be transmitted to apparatus 25 in response.

As shown by operation 202, the apparatus 25 may include means, such as the processor 20, the communication interface 24 or the like, for processing the plurality of camera attributes to determine a seam of a subject image of a scene based on the plurality of camera attributes. The seam may be defined by an area of overlap of two images to be combined as a panoramic image (e.g., the subject image). The subject image may not necessarily be an image that has already been captured or generated. Rather, the subject image may be an estimated, projected, or hypothetical image prior to its capture or creation. As another example, the subject image may be an actual image that has already been captured by camera 30, and the example embodiments provided herein may assist a user in improving subsequent images or video based on those already captured. Regardless of whether the subject image has been captured or is an estimated, projected or hypothetical image to be taken, the term subject image will be used herein.

In addition to or instead of the seam being an adjoining area of two images, as another example, the seam may refer to a boundary of a single subject image (e.g., image already captured or not yet captured). In this regard, the seam may be considered an area surrounding an image and may therefore be considered as an adjoining portion, even if the adjoining image is not yet identified.

The seam may include any number of pixels of the subject image, and may be linear, jagged, straight, and/or curved. In an example in which the subject image is a single image, the seam may be an edge or boundary of the image, so that potential seams if the subject image were combined with others, may still be exposed to the user as described below.

The seam may be determined, estimated or calculated according to any number of the camera attributes. For example, based on the positioning or angle of a camera or cameras 30, the location of the seam relative to the subject image or relative to the camera 30 may be determined. In instances in which the subject image is a panoramic image generated from or to be generated from two or more images, the seam may be determined to be an overlapping area of the images. For example, apparatus 25 may analyze the coordinates in space (e.g., in the scene) of the image to be taken according the camera attributes, and identify common coordinates of two or images to identify the seam.

In some embodiments, such as when cameras 30 are embodied by a 360° imaging device, the seam may be determined based on the position of the device as the position of the cameras may be fixed or predefined within the device. In some examples, multiple seams may be determined. For example, apparatus 25 may determine as many seams as necessary to provide the full 360° imaging, based on the number of and/or angle of all the cameras. For example, one image captured by a camera in a multi-camera system or device may have several seams, such that every edge of an image is a seam or has a seam in close proximity.

In some instances, the seam may be based on the border, boundary or edge of the image determined based on a camera attribute. Any attribute of the camera 30 may be utilized in determining the seam. For example, the zoom level of a camera may affect the portion of the scene captured in the image, and therefore the location of the seam in the subject image. The angle of the camera 30 or a lens may further impact the portion of the scene captured in the image, and therefore the seam. In some examples, the position of the camera 30 in combination with the zoom properties of the camera 30 may be used to determine the location of the seam.

As shown by operation 204, the apparatus 25 may include means, such as the processor 20, the user interface 22, the communication interface 24 or the like, for causing an indication of the seam of the subject image to be provided in the scene. The indication may be provided, for example, visually or audibly in the scene so that users or other directors in the scene are aware of the location of the seam, and may adjust cameras 30 accordingly. As another example, the indication of the seam may indicate to actors or other individuals to move or rearrange objects in the scene.

For example, as shown by operation 206, the apparatus 25 may include means, such as the processor 20, the user interface 22, the communication interface 24 or the like, for causing light to be emitted in the scene in an area corresponding to the seam of the subject image of the scene. For example, camera 30 and/or user device 32 may be equipped with any number of laser lights or other types of lights for emitting an indication (e.g., light) in the area of the scene corresponding to the seam of the subject image. In an instance in which the subject image is a panoramic image generated or to be generated from at least two images, and the seam is determined by identifying overlapping coordinates in space, the light may be emitted into the scene in the position of the overlapping coordinates in space. In this regard, the area of the scene in which the light is emitted corresponds to the seam of the subject image.

In some examples, such as those in which multiple cameras 30 are present (e.g., a 360° imaging device, or other multi-camera setup), a light may be emitted in areas corresponding to multiple seams or every seam. In this regard, a grid-like pattern of lines representing the seams may be emitted by laser light or the like into the scene.

In some examples, apparatus 25 may include means, such as processor 20, the user interface 22, the communication interface 24 or the like, for causing the indication of the seam to be provided in the scene in response to a user input. For example, a user may indicate, such as via camera 30 and/or user device 32 a request for an indication of the seam in the scene of the image. For example, a user may turn on a setting of the camera 30 that causes the indication (e.g., light) to be provided. The setting may be controlled from user device 32 and/or the camera 30.

In some examples, when camera 32 is in an image capturing mode, or is detected to be capturing images, the apparatus 25 may prevent or stop the indication from being provided. For example, the apparatus 25 may be configured to prevent the light indicating the seam from being visible in the captured images and/or subject image.

For example, as shown by operation 208, the apparatus 25 may include means, such as the processor 20, the user interface 22, the communication interface 24 or the like, for determining that a degradation in quality would occur in the subject image based on the determined seam of the subject image of the scene. In this regard, based on the objects in the scene, some areas may be more or less ideal or optimal for generating a panoramic image with clear or disguised seams. Objects in the foreground, or in close proximity to the camera 30 or viewpoint (e.g., within a threshold distance or range) may be more visible to the user than a background of the scene. Similarly, focal objects, such as objects in motion, and/or the like that may be determined as an interest point to the user may also be highly visible to the user relative to other portions of the subject image. Thus, in an example embodiment, the detection of certain types of objects, such as objects in the foreground or objects in close proximity to the camera 30 or focal objects, may indicate that the quality of the subject image will be degraded if a seam crosses such an object.

In some examples, generating a panoramic image such that the seam includes such objects (objects of interest, in the foreground, or within a close proximity of the camera 30) may cause a degradation of the quality in the area of the seam. For example, the area of the seam may be blurred and/or distorted. As such, apparatus 25 may be configured to determine that a degradation in a subject image would or may occur based on the determined seam. The camera 30 may therefore comprise sensors or detectors for sensing such objects in the scene in the area or vicinity corresponding to the determined seam of the subject image. In some examples, imagery representing the subject image may be detected in a viewfinder of the like of camera 30. The apparatus 25 may analyze the area of the scene corresponding to the seam of the subject image of the scene to determine if any objects are situated within the scene that may cause the degradation in the seam(s) of the subject image.

The degradation is considered as possibly occurring, or the apparatus 25 may determine that the degradation would occur because the subject image is not yet necessarily captured or generated from multiple captured images in an instance that the apparatus 25 detects the degradation may occur. In this regard, the determination of the seam, provision of the indication in the scene, and/or the identification of possible degradation may occur prior to the subject image being captured. In some examples, determining that degradation would occur may include determining a rating, score, or other measurable amount of the blur or distortion in the area of the seam, and deeming the area as a degradation if the rating, score or other measurable amount is within a specified or predetermined threshold. As another example, the apparatus 25 may determine the degradation would occur based on a high probability or likelihood of distortion or blurring occurring, and/or the probability of being perceived or detected by a user.

In some embodiments, as introduced above, the subject image may be a single image such that the seams are a border of the single image (and, for example, information identifying an additional image with which to combine the subject image to generate a panoramic image is not yet known). In this regard, apparatus 25 may include means, such as processor 20, for determining that the seam corresponds to a portion of the scene such that combining the subject image with another image at the seam would cause a resulting panoramic image to comprise a degradation in quality at the seam.

For example, as shown by operation 210, the apparatus 25 may include means, such as the processor 20, the user interface 22, the communication interface 24 or the like, for, in response to determining that the degradation in quality would occur, causing a warning to be provided via a user interface, such as user interface 22. The warning may be audial or visual, and may be provided via camera 30 and/or user device 32, for example. In some embodiments, if apparatus 25 determines that a degradation would occur based on the determined seam of the subject image, the apparatus 25 may cause a beeping or similar noise to be emitted as a warning, such as via camera 30 or user device 32.

In some embodiments, the warning may be provided as a visual indication, such as a message or indicator, on a display of camera 30 or user device 32. In some examples, the light emitted by the camera 30 to indicate the seam in the scene may be a designated color, or may flash, to indicate the warning.

A user may adjust any of the camera attributes, such as via camera 30 or user device 32, and the warning may continue to be provided until the clarity of the seam is improved (such as by a predefined amount or percent), the degradation is determined to be decreased (such as by a predefined amount or percent) or eliminated, and/or the like. For example, in an instance in which objects are detected to be in close proximity in the area of the scene corresponding to the seam of the subject image, the warning may be provided until the camera 30 and/or camera attributes are adjusted such that the objects are no longer in the area corresponding to the seam. As another example, a user could move an object away from the area corresponding to the seam. The user may consider the warning and/or the indication of the seam provided in the scene, to direct the camera 30.

Regardless of the implementation of the warning, a user may perceive the warning provided via a user interface and make adjustments until the warning ceases, thus resulting in a better quality subject image than if the subject image was captured prior to the adjustments and/or based on the location of the seam as previously indicated.

In some examples, such as those in which several seams may be present in a subject image, the user may have difficulty in directing the camera 30 to completely avoid degradation in the subject image due to the seams. However, in such an instance, the user may adjust the camera(s) to limit the degradation, or to avoid seams in areas the user deems to be of high importance or focus. In this regard, if it is difficult to avoid blurry seams, the user may at least direct the camera 30 so that the seams are in areas of lesser significance in the subject image, relative to those areas not impacted by the seams. For example, a user may position a 360° imaging so that as few seams as possible are in portions of the subject image corresponding to key areas of the scene.

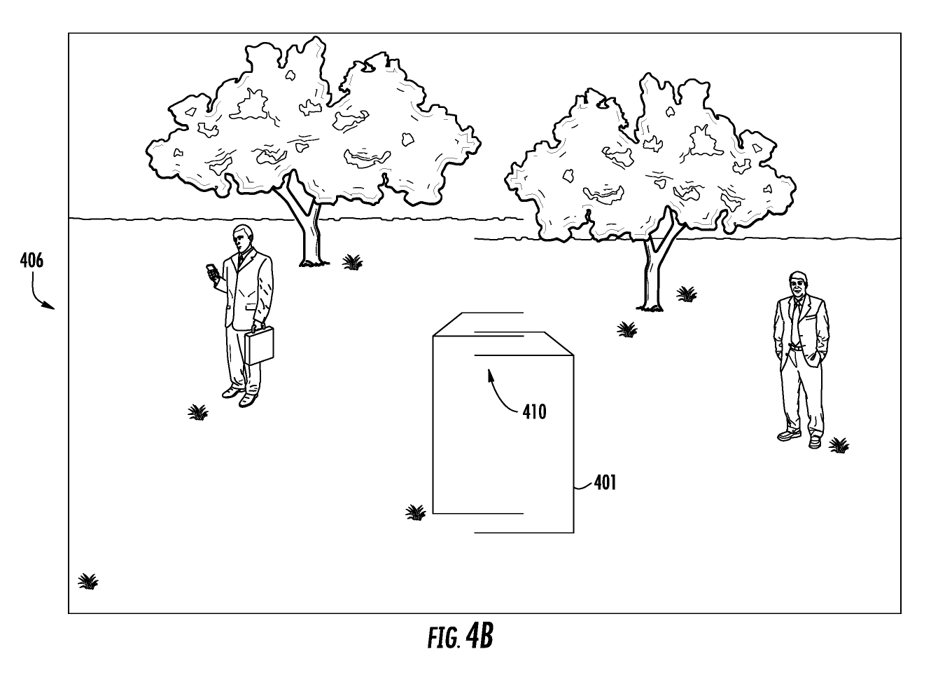

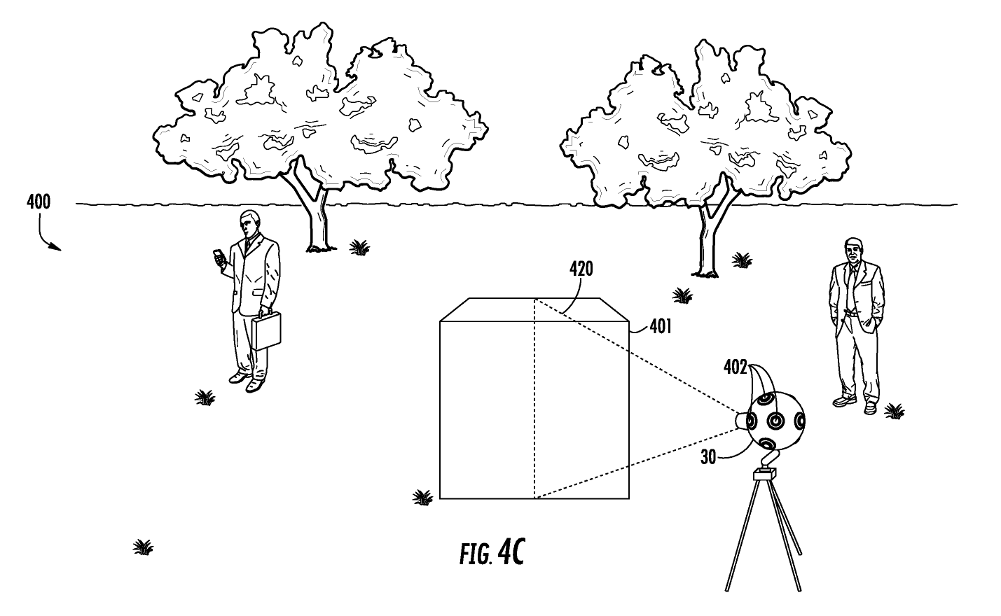

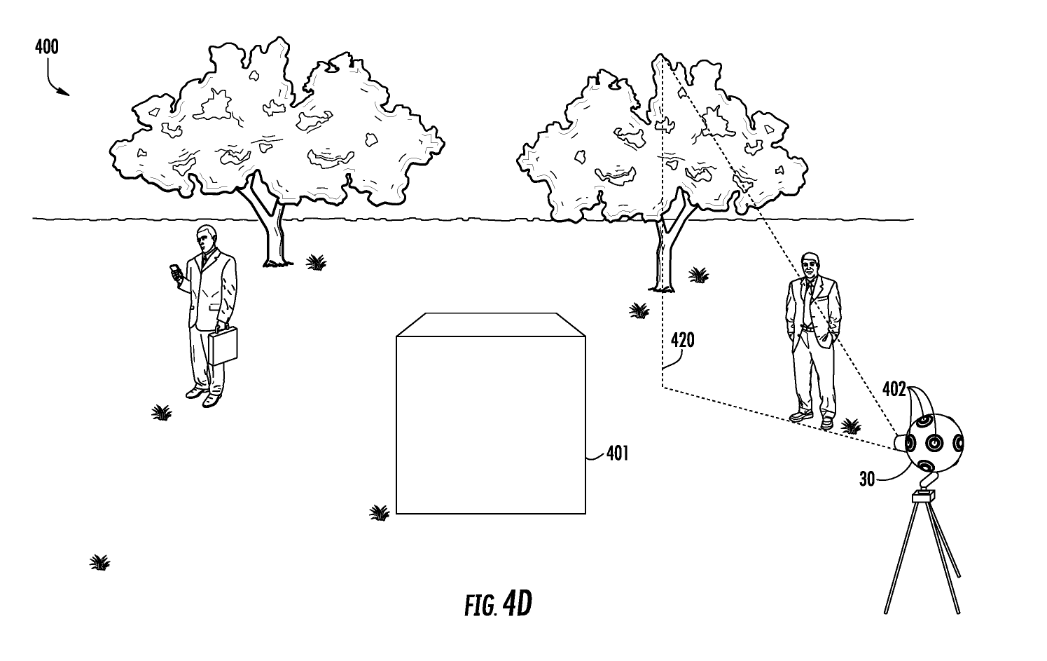

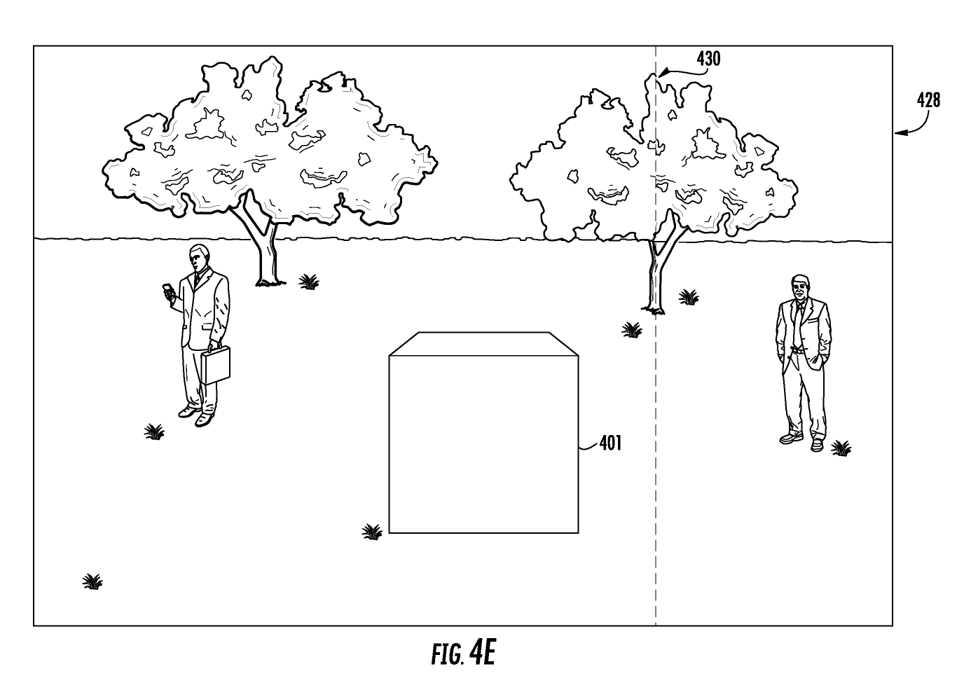

Example embodiments provide many advantages in image capture and panoramic image generation. FIGS. 4A-4E illustrate at least some advantages provided by example embodiments. FIG. 4A is a view of a scene 400. In the scene is an object 401. In this example, the object 401 is a cube, and may be an object of interest, focal point, or foreground object of the scene 400. In the background of the scene are two trees and two men. The camera 30 is positioned to film, or capture images of the scene 400, and include multiple lenses 402. In some examples, the multiple lenses 402 may be considered multiple cameras 30 housed within a single device.

FIG. 4B is a panoramic image 406 of the scene of FIG. 4A, such as that generated from multiple (e.g., at least two images) captured by camera 30. Note that the panoramic image suffers from degradation and blurriness in area 410, where separate images have been stitched together, or combined, to generate the panoramic image 406. The blurriness in area 410 is caused by the seam of the panoramic image. The object 401 appears morphed and distorted in area 410 of the seam.

FIG. 4C is a view of the scene 400 (the same scene as depicted in FIG. 4A), wherein an example embodiment is employed. In this example, an indication 420 of the seam is provided in the scene 400. For example, the indication 420 of the seam may be light emitted from the camera 30. In response, a user may perceive the indication 420 as falling on or near object 401, and may adjust the camera 30 accordingly.

FIG. 4D is a view of the scene of FIGS. 4A and 4C, wherein an example embodiment is employed, and the camera 30 has been adjusted. In FIG. 4D, the indication 420 of the seam falls in the background, and not on the object 401.

FIG. 4E is a panoramic image 428 of the scene of FIG. 4C, generated from multiple images captured by camera 30, and wherein an example embodiment is employed. The seam 430 is shown by a dashed line, although the dashed line may not be present in the actual panoramic image 428. The dashed line is provided merely to highlight the seam 430, as the seam 430 may be well-disguised, completely hidden, or only scarcely visible to the user. Note that object 401 is clearly intact and free of blur and degradation. The improvement in the panoramic image 428 relative to the panoramic image 406 may be attributed to example embodiments (e.g., due to a user repositioning, or changing attributes of, the camera 30).

Example embodiments provide many advantages in image capture and panoramic image generation. Causing the indication of the seam to be provided in the scene, instead of or in addition to providing the indication of the seam via a display of the device for example, may allow a larger number of users in the vicinity of the scene to view the seam indications, and direct camera(s) and/or rearrange the scene accordingly. As another example, actors or other individuals in the scene may react accordingly to avoid (or to move objects away from) areas of the scene corresponding to seams. Example embodiments of apparatus 25 may therefore provide high quality subject images, including panoramic images that provide continuity along the seams of adjoining images. The seams may be disguised such that a viewer cannot easily identify the seams. Example embodiments may facilitate the capture and/or generation of such high quality images that the viewer may not even realize that the subject image is generated from multiple images stitched together. In this regard, a resulting panoramic image may include smoother seams than those generated from images captured without the guidance of an example embodiment.

As described above, FIG. 3 illustrates a flowchart of an apparatus 25, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 26 of an apparatus 25 employing an embodiment of the present invention and executed by a processor 20 of the apparatus 25. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
receive a camera attribute indication, wherein the camera attribute indication comprises at least one camera attribute;
process the at least one camera attribute to determine a seam of a subject image of a scene based on the at least one camera attribute; and
cause an indication of the seam of the subject image to be provided in the scene.

2. The apparatus according to claim 1, wherein causing the indication of the seam to be provided in the scene comprises causing light to be emitted in the scene in an area corresponding to the seam of the subject image of the scene.

3. The apparatus according to claim 1, wherein the subject image is a panoramic image to be generated by adjoining two images at the seam, and the at least one camera attribute comprises at least two camera attributes attributed to at least two different cameras.

4. The apparatus according to claim 1, wherein the indication of the seam of the subject image is provided in the scene in response to a user input requesting the indication of the seam.

5. The apparatus according to claim 1, wherein the at least one memory and the computer program code are further configured to cause the apparatus to at least:
determine that a degradation in quality would occur in the subject image based on the determined seam of the subject image of the scene.

6. The apparatus according to claim 5, wherein determining that the degradation in quality would occur comprises:
determining that an object within the area of the scene corresponding to the seam is within a threshold distance of a camera.

7. The apparatus according to claim 5, wherein the at least one memory and the computer program code are further configured to cause the apparatus to at least:
in response to determining that the degradation in quality would occur, cause a warning to be provided via a user interface.

8. A computer program product comprising at least one non-transitory computer-readable storage medium having computer-executable program code instructions stored therein, the computer-executable program code instructions comprising program code instructions to:
receive a camera attribute indication, wherein the camera attribute indication comprises at least one camera attribute;
process the at least one camera attribute to determine a seam of a subject image of a scene based on the at least one camera attribute; and
cause an indication of the seam of the subject image to be provided in the scene.

9. The computer program product according to claim 8, wherein causing the indication of the seam to be provided in the scene comprises causing light to be emitted in the scene in an area corresponding to the seam of the subject image of the scene.

10. The computer program product according to claim 8, wherein the subject image is a panoramic image to be generated by adjoining two images at the seam, and the at least one camera attribute comprises at least two camera attributes attributed to at least two different cameras.

11. The computer program product according to claim 8, wherein the indication of the seam of the subject image is provided in the scene in response to a user input requesting the indication of the seam.

12. The computer program product according to claim 8, wherein the computer-executable program code instructions further comprise program code instructions to:
determine that a degradation in quality would occur in the subject image based on the determined seam of the subject image of the scene.

13. The computer program product according to claim 12, wherein determining that the degradation in quality would occur comprises:
determining that an object within the area of the scene corresponding to the seam is within a threshold distance of a camera.

14. The computer program product according to claim 12, wherein the computer-executable program code instructions further comprise program code instructions to:
in response to determining that the degradation in quality would occur, cause a warning to be provided via a user interface.

15. A method comprising:
receiving a camera attribute indication, wherein the camera attribute indication comprises at least one camera attribute;
processing, with a processor, the at least one camera attribute to determine a seam of a subject image of a scene based on the at least one camera attribute; and
causing an indication of the seam of the subject image to be provided in the scene.

16. The method according to claim 15, wherein causing the indication of the seam to be provided in the scene comprises causing light to be emitted in the scene in an area corresponding to the seam of the subject image of the scene.

17. The method according to claim 15, wherein the subject image is a panoramic image to be generated by adjoining two images at the seam, and the at least one camera attribute comprises at least two camera attributes attributed to at least two different cameras.

18. The method according to claim 15, wherein the indication of the seam of the subject image is provided in the scene in response to a user input requesting the indication of the seam.

19. The method according to claim 15, further comprising:
determining that a degradation in quality would occur in the subject image based on the determined seam of the subject image of the scene.

20. The method according to claim 19, wherein determining that the degradation in quality would occur comprises:
determining that an object within the area of the scene corresponding to the seam is within a threshold distance of a camera.

21. The method according to claim 19, further comprising:
in response to determining that the degradation in quality would occur, causing a warning to be provided via a user interface.
